(19) United States
(12) Patent Application Publication
(10) Pub. No.: US 2025/0162415 A1
(43) Pub. Date: May 22, 2025

(54) Systems, Methods, and Devices for Point of Interest Identification and Dynamic Shading of a Display

(71) Applicant: Supernal, LLC, Washington, DC (US)

(72) Inventors: Christian Moreno, Washington, DC (US); Alex Pozzi, Washington, DC (US)

(21) Appl. No.: 18/843,610

(22) PCT Filed: Mar. 16, 2023
(86) PCT No.: PCT/US2023/064506

§ 371 Date: Sep. 3, 2024

Related U.S. Application Data
(60) Provisional application No. 63/269,589, filed on Mar. 18, 2022.

(51) Int. Cl. B60K 35/28; B60K 35/40

(52) U.S. Cl. CPC B60K 35/28; B60K 35/40; B60K 2360/1438; B60K 2360/149; B60K 2360/166

(57) ABSTRACT

Exemplary disclosed embodiments include systems, methods, and devices for an vehicle display system. The systems, methods, and devices may include a processor, one or more receivers, wherein the one or more receivers receive navigational information, wherein the processor determines a position of an vehicle relative to a position based on the navigational information and the eye movement, wherein the processor determines a surrounding of the vehicle; and at least one translucent screen configured to show the surrounding of the vehicle, wherein the processor is configured to illustrate data based on the navigational information on the at least one display.

### RELATED APPLICATIONS

This application claims the benefit under 35 U.S.C. § 119(e) to U.S. Provisional Application No. 63/269,589 filed Mar. 18, 2022, which application is incorporated by reference herein in its entirety.

### FIELD OF THE DISCLOSURE

The present disclosure relates to systems, methods, and devices for a passenger experience of a vehicle.

### BACKGROUND

Windows and displays are currently used for vehicle or aircraft passengers to enhance the experience of travel. Windows and displays provide entertainment, for example: windows may show an outside environment and displays, such as traditional televisions or flatscreen displays may be used to show media, entertainment, information, or safety briefings. Additionally, some vehicles may use a heads-up-display
to provide information, such as navigation information (e.g., turn-by-turn directions, speed, or points of interest).

Conventionally, air, ground or sea vehicles have implemented these types of screens in an attempt to convey information or media. However, these known systems may distract from or omit the environment around the vehicle. Furthermore, these screens can cause night-blindness, blurred vision, and other ocular issues which can create issues for an operator or passenger attempting to see outside the vehicle. While conventional systems may use dimming or other similar features to account for interior light conditions, these same issues can occur, for example, when a pilot, operator, or passenger fails to utilize such features or utilize them improperly. And, even when such features are utilized properly, it can still be difficult for an individual to view the environment outside the vehicle.

Accordingly, consistent with disclosed embodiments, display systems would be improved by providing a display of the environment surrounding a vehicle and by providing additional information as to what the user is viewing on a screen. Also, consistent with disclosed embodiments, display systems may be improved by using user inputs or a user eyes to determine what is being viewed and to provide information on what is being viewed. Also, consistent with disclosed embodiments, display systems may be improved by adjusting dim settings appropriate to the environment or the inside of the vehicle or to highlight or improve visibility of displayed text.

### SUMMARY

In the following description, certain aspects and embodiments will become evident. It is contemplated that the aspects and embodiments, in their broadest sense, could be practiced without having one or more features of these aspects and embodiments. It is also contemplated that these aspects and embodiments are merely exemplary.

Exemplary disclosed embodiments include systems, methods, and devices for display systems for a vehicle. For example, in some embodiments, a processor, one or more receivers, wherein the one or more receivers may receive navigational information, wherein the processor may determine a position of a vehicle relative to a position based on the navigational information and the eye movement, wherein the processor determines a surrounding of the aircraft. Disclosed embodiments may further include at least one screen configured to display the surrounding of the vehicle, wherein the at least one screen may be translucent or transparent, wherein the at least one screen may display data based on the navigational information. In some embodiments, a portion of the at least one screen may be transparent and a portion may be translucent. In some embodiments, the screen may be configured to selectively shade a portion of the at least one screen. In some embodiments, a sensor may determine an eye movement of a user, and the at least one screen may display the data on one display of the at least one screen.

It is to be understood that both the foregoing general description and the following detailed description are exemplary and explanatory only and are not restrictive of the invention. The accompanying drawings, which are incorporated in and constitute a part of this specification, illustrate several exemplary embodiments and together with the description, serve to outline principles of the exemplary embodiments.

### BRIEF DESCRIPTION OF THE DRAWINGS

The accompanying drawings, which are incorporated in and constitute a part of this specification, illustrate multiple embodiments of the presently disclosed subject matter and, together with the description, serve to explain the principles of the presently disclosed subject matter; and, furthermore, are not intended in any manner to limit the scope of the presently disclosed subject matter.

FIG. 1 depicts a display system consistent with disclosed embodiments.

FIG. 2 depicts a display method consistent with disclosed embodiments.

FIG. 3 depicts a display system consistent with disclosed embodiments.

FIGS. 4A-4C depict an exemplary display system consistent with disclosed embodiments.

FIG. 5 depicts a display system consistent with disclosed embodiments.

### DESCRIPTION OF EXEMPLARY EMBODIMENTS

Reference will now be made in detail to exemplary embodiments, shown in the accompanying drawings.

Exemplary disclosed embodiments include systems, methods, and devices for display systems for vehicles. The systems, methods, and devices may include a processor, one or more receivers, wherein the one or more receivers may receive navigational information. The processor may determine a position of a vehicle relative to a position based on the navigational information. The processor may determine a surrounding of the vehicle. The at least one display may show the surrounding of the vehicle, wherein the at least one display may be translucent or transparent, and wherein the at least one may display data based on the navigational information. In some embodiments, a portion of the display may be transparent and a portion may be translucent. In some embodiments, the display may be configured to selectively shade a portion of the screen. In some embodiments, a sensor may determine an eye movement of a user, and the at least one display may be configured to display the data on at least one display.

Benefits of disclosed embodiments include allowing passengers and/or operators to view and/or interact with an environment of a vehicle. Benefits can also include alleviating night-blindness, disorientation, blurring, or other ocular issues caused by shifting from a screen to an environment. Benefits can also include helping operators to stay focused on terrain in addition to instruments and navigation systems. Benefits can also include supplying media and information to operators and passengers in an aesthetically pleasing way.

An aircraft may refer to an aerial, floating, soaring, hovering, airborne, aeronautical aircraft, airplane, spacecraft, plane, or other vehicles moving or able to move through air. Non-limiting examples may include a helicopter, an airship, a hot air balloon, an autonomous aerial vehicle, a vertical takeoff craft, or a drone.

As referred to herein, a spacecraft can refer to a vehicle or machine designed to fly or orbit in outer space. Examples of spacecraft include shuttles, stations, planes, modules, satellites, capsules, probes, or the like.

A sea-based vehicle may refer to a watercraft that is used on water or underwater. A sea-based vehicle can include a propulsive capability, such as a sail, oar, paddle, or engine, or motor. Examples of sea-based vehicle include a submarine, an underwater robot, a sailboat, a pontoon boat, riverboat, ferry boat, tugboats, towboats, steamboats, hovercraft, yacht, tanker, container ship, cruise ship, motorboat, kayak, frigate, fishing boat, cruiser, catamaran, cutter, or the like. In some embodiments, sea-based vehicle may be powered using electricity. In some embodiments, sea-based vehicle may be powered using fossil fuels. In some embodiments, sea-based vehicle may be powered using fossil fuels and electricity in a hybrid configuration.

A ground-based vehicle may refer to a train or an automobile. A train may refer to a one or more connected vehicles pulled or pushed by a locomotive, or self-propelled, that run along a track and configured to transport people and/or freight. A train can include a steam, natural gas, hydrogen, diesel, or electric locomotives. Types of trains include high-speed rail, commuter rail, light rail, monorails, or funiculars. In some embodiments, trains may be powered using electricity. In some embodiments, trains may be powered using fossil fuels. In some embodiments, trains may be powered using fossil fuels and electricity in a hybrid configuration.

An automobile may refer to a motor vehicle with wheels. An automobile can include an internal combustion engine, an electric motor, or a hybrid. Types of automobiles include sedans, hatchbacks, trucks, lorries, vans, tractors, SUVs, crossovers, jeeps, or the like. In some embodiments, trains may be powered using at least one of: fossil fuels, electricity, hydrogen, natural gas, or solar power. In some embodiments, automobiles may be plug-in hybrids, hybrids, all electric, or the like.

As referred to herein, a vehicle may be at least one of: an aircraft, a ground-based vehicle, or a sea-based vehicle.

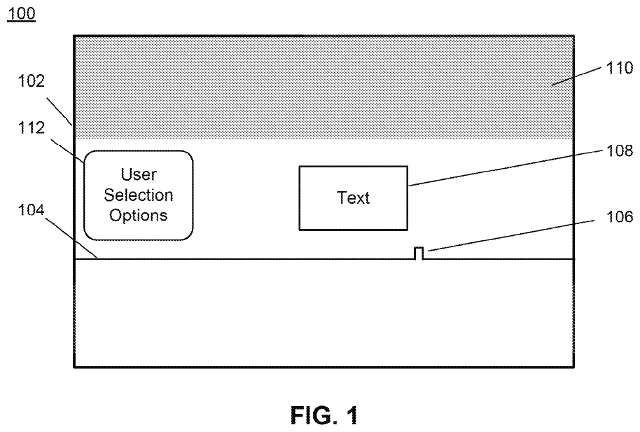

FIG. 1 depicts a display system consistent with disclosed embodiments. By way of example, FIG. 1 illustrates a display system 100 consistent with disclosed embodiments. As illustrated in FIG. 1, display system 100 may comprise display 102. Display 102 can include a screen adjacent to a window, for example, of an aircraft window, a car window, or a boat window. For example, display 102 may be overlayed on top of a window. In some embodiments, display 102 may be inside a vehicle and separate from a window (e.g., on a back of a seat, on a dashboard or other interior surface). In some embodiments, display 102 can include a screen that comprises a portion of a window. Display 102 may be operatively connected to a touchscreen, a controller, controls of a screen through wired or wireless devices, or one or more buttons or display 102 may include a touchscreen.

In some embodiments display 102 may be configured to be transparent or translucent. For example, display 102 may be configured to show a surrounding environment. The surrounding environment may include, for example, a horizon 104. The surrounding environment may include, for example, air or ground features, such as ground feature 106. Ground feature 106 can be, for example, a landmark, a building, or a point of interest or another feature of a landscape or seascape (e.g., trees, a cove, a beach, a waterway, a roadway, a mountain, a canyon, an airport, farmland, a vehicle). Ground feature 106 can be a building. Display 102 may be configured to show a display while also allowing a user to view the surrounding environment. The display may include one or more of text 108, shading 110, and user selection options 112.

Text 108 can be informational text describing ground feature 106. For example, a processor associated with display system 100 may determine a position of the vehicle and an orientation of the screen to show text or date based on ground feature 106. For example, text 108 can include height information, historical information, distance information, or similar information.

Shading 110 may be configured to block incoming light into a cabin of the vehicle. The processor may determine whether to use shading 110 based on one or more of the time of the day, the orientation of the display, and the position of the vehicle. Shading 110 may be configured to be more or less transparent, translucent, or substantially opaque. Shading 110 may include geometric shape shading. Shading 110 may include an increased amount of shading where a light source is detected, for example, the sun, and a decreased amount of shading away from the light source.

User selection options 112 may be configured to allow a user to determine how to adjust the display. For example, user selection options 112 may be connected to one or more buttons of the vehicle and/or touchscreen input. User selection options 112 can allow a user to adjust a level of shading 110, for example, on a spectrum from transparent to opaque. User selection options 112 can allow a user to adjust an amount of shading 110, for example, on a spectrum from fully covered by shading 110 to not covered by shading 110. User selection options 112 can request information regarding a selected environment, weather, or route feature.

Text 108 and/or user selection options 112 may be shown regardless of the state of shading 110 (e.g., whether shading 110 covers display 102 or whether shading 110 does not cover any portion of display 102 or anywhere in between). For example, text 108 may be displayed as a contrast to either a portion of the surrounding environment, for example, a cloud, a ground/sea, a sky, or similar. For example, text 108 may be white when the surrounding environment is dark, or vice versa.

Data may be displayed on display 102, for example, text 108 or navigational information, safety displays or videos, maps of the vehicle or the surrounding environment. In some embodiments, data may be overlayed on the surrounding environment through display 102. The data may be visual graphic, text, or visual media.

In some embodiments a sensor interior to a vehicle, such as an optical sensor or an infrared sensor, may sense a user's movements to determine a display on which to show data. For example, a processor may determine, based on information from the sensor, to show information on a display associated with a first window, such as display 102, an entertainment screen, or another display associated with a second window. In some embodiments, the sensor interior to the vehicle may be configured to track a user's movement, for example, standing up, turning the user's head, or similar movement. In some embodiments, the sensor interior to the vehicle may be configured to track a user's eye movement, for example, a direction of an eye shape or when a pupil moves to a position or in a direction. In some embodiments the sensor interior to the vehicle may include a seat belt contact sensor, for example, that senses whether a seat belt is engaged. As examples of controls responsive to the sensors, the display may turn on when the seat belt is engaged, when a user looks at the screen, or when a combination of the above occurs (e.g., a seat belt is engaged and the user looks at display 102). Other sensors may include a seat sensor (e.g., a force sensor that detects whether weight is being applied to the seat or backrest of the seat or other sensor associated with a passenger sitting in a seat), a sensor that can determine an object or passenger's presence (e.g., infrared, camera, radar), or a microphone or visual sensor to determine the presence of a passenger.

In some embodiments a processor may determine contents or an operational state (e.g., on/off) of display 102 based on a lack of interaction from a user. In some embodiments display 102 may display data associated with a user's connecting flight or next destination. In some embodiments, display 102 may display data to assist with embarking or disembarking.

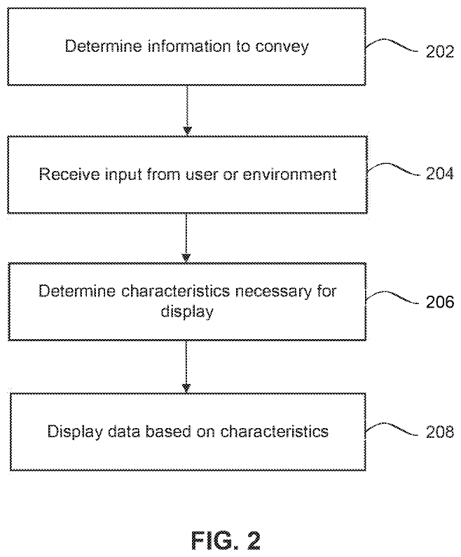

FIG. 2 depicts a display method consistent with disclosed embodiments. By way of example, FIG. 2 illustrates a display method 200 consistent with disclosed embodiments. As depicted in FIG. 2, display method 200 may comprise one or more of steps 202, 204, 206, and 208. Steps 202, 204, 206, 208 may be steps performed by a processor associated with the vehicle. Method 200 may be performed in any order. The processor may be operably connected to a non-transitory medium. Step 202 may include a step of determining information to convey to a user, such as a passenger. Step 202 may include determining an orientation of a display, e.g., display 102, and a position of the vehicle, such that the processor may determine a direction the display is facing, for example, towards or away from a light source, or towards or away from a landmark or point of interest.

Step 204 may include a step of receiving input from a user or an environment. For example, a processor may receive information from a sensor, such as a navigational sensor of the vehicle. The navigational sensor may be one or more of a global positioning system, an inertial navigation system, an angle of attack sensor, a turn coordinator sensor, a directional sensor, and/or a speed sensor. The speed sensor may be an airspeed sensor, a speedometer, a pitometer, or any other sensor configured to measure speed. Navigational information may be information overlaid on a map to include weather information such as past, current, or predicted weather, route information, information from any sensor of the vehicle (e.g., speed, acceleration), calculated information such as estimated-time-of-arrival or expected duration of the trip, traffic information, or similar. Navigational information may be acquired from an internal database, a wireless network, or any other network for conveying data. In some embodiments, the sensor may be an interior light sensor, an exterior light sensor. When sensing light, the sensor may be configured to sense an intensity of the light and/or a direction of the light. The sensor may be configured to determine an intensity of the light at different locations of the display. In some embodiments, the processor may estimate the intensity of the light at different locations of the display. In some embodiments, the processor may estimate the intensity of the light based on navigation information such as one or more of a vehicle's position, local weather or building/landscape features, a vehicle's height, a vehicle's direction, and a vehicle's orientation.

Step 206 may include a step of determining characteristics necessary for display. For example, step 206 may include a processor determining, based on if the display is facing a landmark, the information to display that is associated with the landmark. Step 206 may include comparing or aggregating information from one or more inputs. For example, step 206 may include determining a position, an orientation, a speed, and/or a velocity of a vehicle from one or more navigational sensors. In some embodiments, step 206 may include determining a height of the vehicle, where the vehicle is an aircraft. Step 206 may also include determining a position and/or an orientation of a display of the vehicle relative to the position and/or the orientation of a building. In some embodiments, step 206 may include a processor determining, based on an external sensor exterior of a cabin of the vehicle whether to dim or intensify the data on display. The dimming or intensifying may occur over the entire display or local to specific portions. For example, if a relatively intense light is sensed at a first location of the display and not a second portion of the display, then the display at the first location may be adjusted to shade the intense light and/or intensify the contents of the display at the first location. In some embodiments, step 206 may include a processor determining, based on a sensor associated with an interior of a cabin of the vehicle whether to dim or intensify the brightness, contrast, or other visibility feature of data on display. Step 206 may include a processor determining whether to change color or intensity of graphics based on the presence or absence of shading (e.g., shading 110). Step 206 may include a processor receiving inputs from a user interface to change a contrast, to increase or decrease shading, or to otherwise improve visibility of the environment and/or displayed data. Step 206 may include a processor receiving inputs as to selections of a user through a user interface as to overlay information to display such as information relevant to a route, an estimated path, an estimated time of arrival, a weather at a location or information relevant to a feature of a landscape or seascape or any other information consistent with embodiments disclosed herein.

In some embodiments, step 206 may include receiving a height of a passenger or a passenger's eyes and determining the display based on the angle that the passenger will view the display. A passenger's height or a height of a passenger's eyes may be known, determined, or based on a nominal position, consistent with embodiments disclosed herein. The height of a passenger or a passenger's eyes may be used to determine an angle and/or distance from the passenger to the display. The height of a passenger or a passenger's eyes may be used to determine an angle and/or distance from the passenger to the display. The height of a passenger or a passenger's eyes may be used to determine what the passenger can view outside a window of the vehicle. For example, a shorter person may see a building at a certain angle, but a taller person may see the building at a different angle. In some embodiments, the building may be a building of interest, for example, a destination of the vehicle, a landmark, another vehicle, or similar.

Step 206 may include receiving input related to weather, for example, clear, cloudy, or partly cloudy. The display may be determined based on weather, for example, whether land, buildings, or landmarks are visible. For example, in cloudy weather, the display may be configured to display an outline of a city, building, body of water, or landmark. As another example, in cloudy weather, the display may be configured to not show data. As another example, in clear weather, the display may display text near a building.

Step 206 may include determining the position, the orientation, the speed, and/or the velocity of a vehicle relative to a building based on a map. For example, where the vehicle is an aircraft, the map may be compared with aircraft navigational information such as height, position, and orientation, to determine a building viewable from the aircraft. In some embodiments, the map may be a three-dimensional map. In some embodiments, where the vehicle is an aircraft, the fidelity of the map may change based on the height of the aircraft. For example, a higher altitude aircraft may comprise a display that illustrates a city, a body of water, or a building viewable from a higher altitude. As another example, a lower altitude aircraft may comprise a display that illustrates a building or a park viewable from a lower altitude. In some embodiments, the map may be used to determine a position of the vehicle relative to the sun.

Step 206 may include receiving information from a camera external to a vehicle. In some embodiments, an image or video from the camera may be used to determine the presence of a building. For example, the image or video may be compared with vehicle navigational information such as height, position, and orientation, to determine a building viewable from the vehicle.

Step 206 may include receiving information from a sensor external to a vehicle to detect a position of a light source, such as the sun.

Step 208 may include displaying data based on the characteristics. In some embodiments, displaying data may include the one or more processors aggregating or comparing information from one or more sensors to display, such as the display shown in FIG. 1. In some embodiments, displaying data may include determining additional data to display, such as determining a building viewable within a window and within the display and performing identification of one or more features of the building. The identification may include highlighting, adding text, adding an estimated time of arrival, or other information consistent with this disclosure. The estimated time of arrival may include air travel time and ground travel time. As another example, displaying data may be based on an angle and/or position of a passenger relative to the display. For example, highlighting a building may include determining a viewable building from a passenger based on the passenger's height and determining the building based on a position of the vehicle relative to the building, and displaying information about the building. In some embodiments, highlighting the building may include adding color or intensity to the determined building, for example, based on edge tracing of the building.

In some embodiments, displaying data may include shading (e.g., shading 110) where a light source external to the vehicle, such as the sun, is determined or detected. In some embodiments, the method 200 may be used as to a central processor and the shading may be determined and controlled for all windows simultaneously. In some embodiments, the central processor may determine a shading pattern and/or a media for each window individually. In some embodiments, the shading pattern and/or media may be changed individually by a passenger and/or operator.

It is to be understood that the configuration and boundaries of the functional building blocks of system 200 have been defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. It is to be understood that steps such as those described in FIG. 2 are illustrative and the order of the steps may be changed. Additionally, intermediate steps may be introduced. For example, intermediate steps consistent with the disclosed embodiments may be added between steps or before or after any of the steps of FIG. 2.

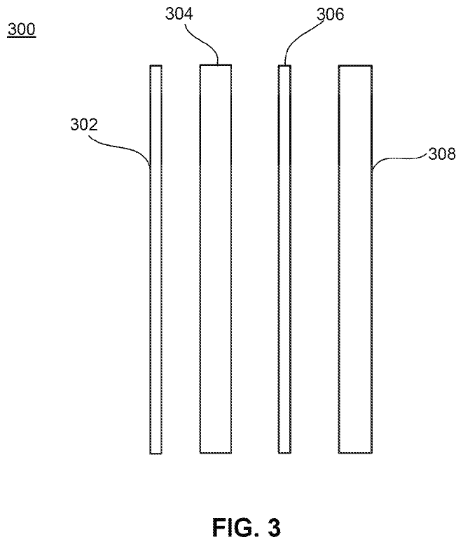

FIG. 3 depicts a display system consistent with disclosed embodiments. By way of example, FIG. 3 illustrates a display system 300 consistent with disclosed embodiments. As illustrated in FIG. 3, display system 300 may comprise interior window 304, display 306, and exterior window 308. In some embodiments, display system 300 may comprise screen 302. Screen 302 can be a display adjacent to a window that may be, for example, an aircraft window. Screen 302 may be a touchscreen or another display consistent with disclosed embodiments.

In some embodiments, interior window 304 may seal a vehicle from the outside. In some embodiments, a gas may be trapped between interior window 304 and exterior window 308. In some embodiments, the gas may act as insulation. In some embodiments, exterior window 308 is exterior of interior window 304, and exterior window 308 may seal a vehicle from the outside.

In some embodiments, display 306 may be between interior window 304 and exterior window 308. In some embodiments, display 306 may be interior of interior window 304. For example, display 306 may be adjacent to or include screen 302.

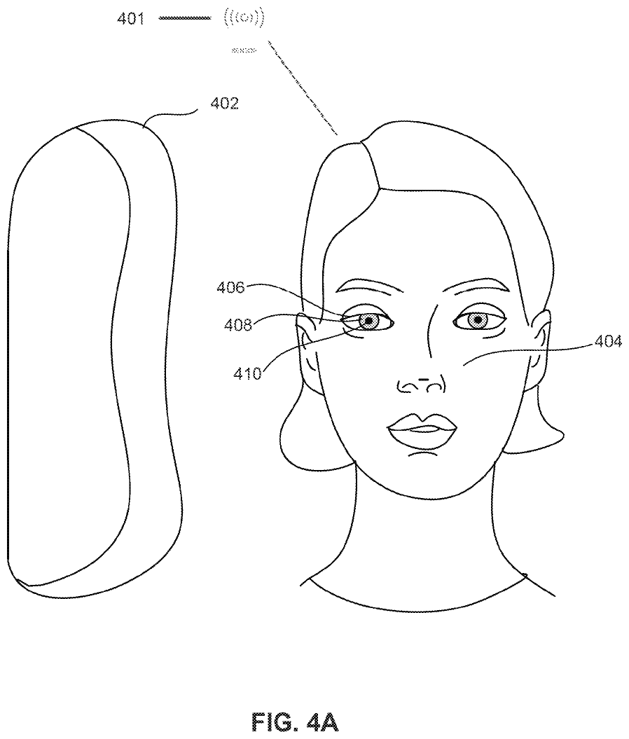

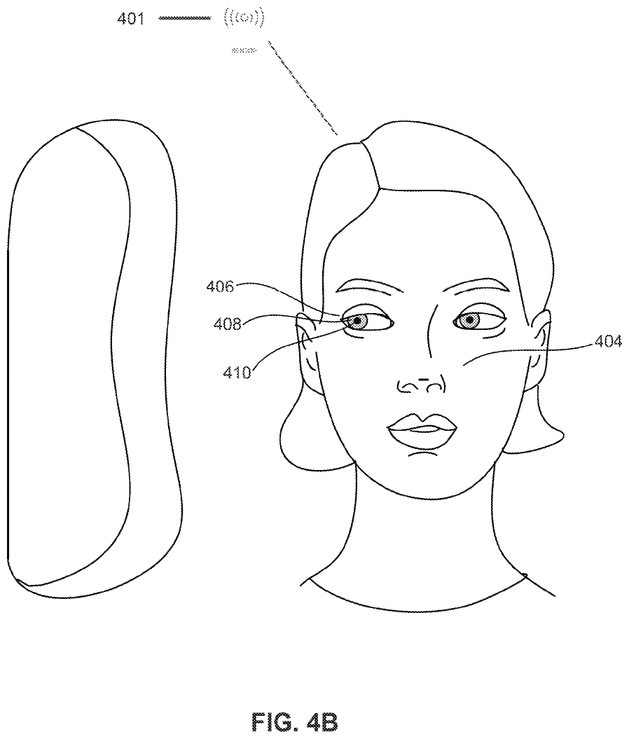

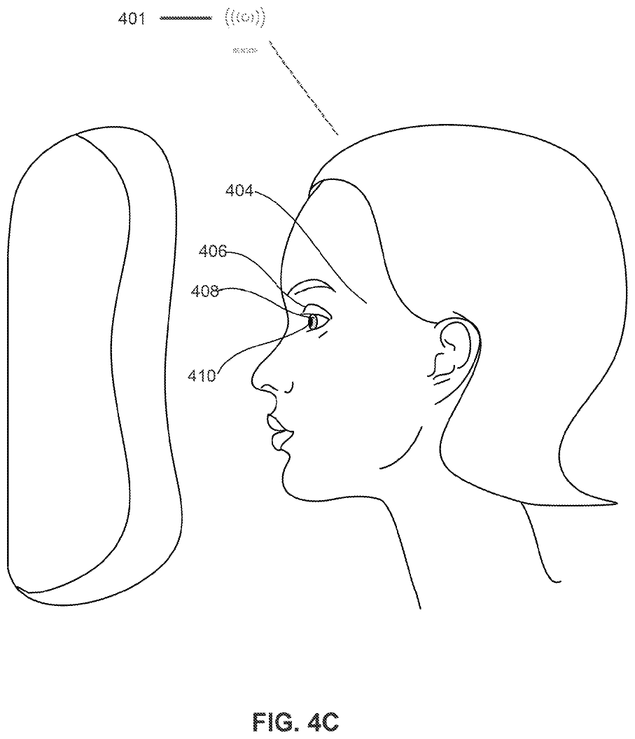

FIGS. 4A-4C depict display systems consistent with disclosed embodiments. By way of example, FIGS. 4A-4C illustrate display systems consistent with disclosed embodiments. As illustrated in FIG. 4A, a sensor 401 interior to a vehicle may sense one or more of a user. Sensor 401 may be a camera, video recorder, motion sensor, or other sensor configured to detect one or more features of a user or operator. For example, sensor 401 may sense a user's face 404 including one or more facial features such as eye shape 406, iris 408, and pupil 410. The display system may include display 402 adjacent to a window, consistent with disclosed embodiments. In some embodiments, the display system may include a display on a surface of an vehicle such as a ceiling display or a display on a seatback. Although certain facial features are listed herein, other facial features such as lips, nose, or face shape could also be detected and used to determine displacement and/or movement.

Sensor 401 may determine a nominal position or determined position of a user or a passenger, such as face 404 or facial features when the user or passenger is sitting in an upright position and facing forward. Sensor 401 may be configured to measure movement, a direction of movement, or a displacement of face 404 or one or more facial features from the nominal position or determined position. Sensor 401 may be configured to determine whether a user's eyes are open or closed, for example, based on eye shape, color, or movement. In some embodiments, sensor 401 may be configured to determine whether a user is squinting or reading, based on a change in eye shape, color, or a movement of a user's head.

Sensor 401 may be configured to adjust such as to allow more or less light through one or more apertures of a camera, to adjust position such as to move to capture a feature associated with a person, to increase or decrease a gain of a microphone, to increase or decrease a sensitivity of a sensor, or to zoom in or zoom out a camera to capture a feature associated with a person within a frame. In some embodiments, sensor 401 may be configured to be adjusted to increase a sensitivity of a force sensor to determine if a user is present. In some embodiments, sensor 401 may be configured to be adjusted to increase a sensitivity of a light sensor. In some embodiments, sensor 401 may be associated with an actuator to change one or more positions of sensor 401.

Because a nominal position can change from user to user, a processor associated with sensor 401 may be configured to determine a nominal position, for example, based on a person sitting for a period of time. In some embodiments, sensor 401 may be used to adjust the nominal position based on a height of a user or a passenger. In some embodiments, sensor 401 be used to adjust the nominal based on a center axis of a person's face, such as a measured distance between a user's eyes. In some embodiments, sensor 401 may be used to adjust the nominal position based on a center of a seat, such as a center axis between a left side of the seat and a right side of the seat, or a horizontal axis based on a top of the seat. For example, the seat may be configured to adjust one or more of up or down, left or right, or to recline.

In some embodiments, sensor 401 may be on a ceiling looking down on a user. In some embodiments, sensor 401 may be on a surface in front of a user, such as a seat-back, wall, tray table, or compartment surface.

Sensor 401 may be configured to determine whether one or more of face 404 and facial features 406, 408, 410, move towards or change in displacement so as to move closer to screen 402 from the nominal position.

As illustrated in FIG. 4B, sensor 401 may detect a change in position, a movement, or a direction of movement of one or more facial features, such as pupil 408 and iris 410. For example, sensor 401 may detect when the user looks towards display 402. Consistent with the embodiments discussed herein, display 402 may display shading, media, entertainment, or safety information or briefings when the user looks towards display 402. Alternately, display 402 may turn off when a user looks away from display 402.

As illustrated in FIG. 4C, sensor 401 may detect a change in position, a movement, or a direction of movement of face 404. For example, sensor 401 may detect when the user turns its head to look towards display 402. Consistent with the embodiments discussed herein, display 402 may display shading, media, entertainment, or safety information or briefings when the user looks towards display 402. Alternately, display 402 may turn off when a user looks away from display 402.

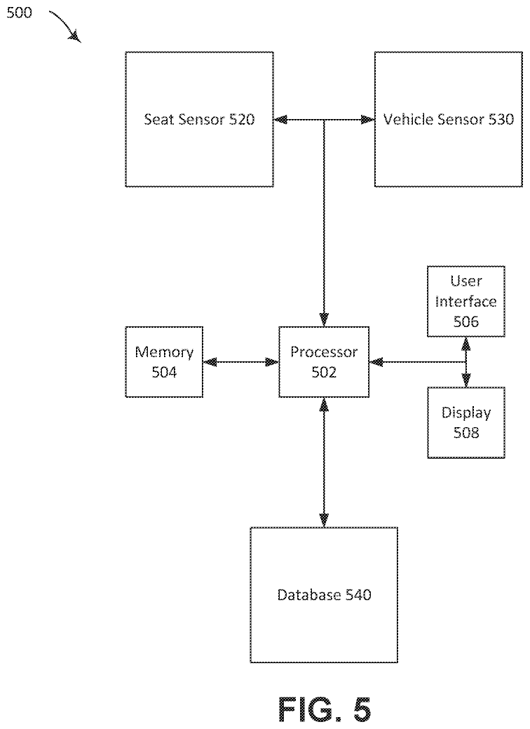

FIG. 5 depicts a display system consistent with disclosed embodiments. As illustrated in FIG. 5, display system 500 may include processor 502. Processor 502 may be associated with a display. Processor 502 may be configured to operate a single display or multiple displays. Processor 502 may be located proximate to the one or more displays or it may be centrally located in a vehicle and in communication (e.g., wired or wireless) with the one or more displays.

Processor 502 may be configured to execute instructions stored on memory 506. Memory 506 may be any memory for short or long term memory storage and/or for use in conjunction with processor 502 to read or store data associated with the display.

Display system 500 may include one or more of components including user interface 506, display 508, seat sensor 520, vehicle sensor 530, and database 540. Any of these components may be associated with one or more processors configured to receive inputs or provide outputs and/or control the components. Processor 502 may be configured to communicate with display 508 or user interface 506 through a wired or wireless communication. Processor 502 may be configured to communicate with seat sensor 520, vehicle sensor 530, or database 540. For example, processor 502 may be configured to communicate through one or more software communication modules or communication hardware (e.g., a transceiver configured to transmit over an available short-range wireless communication system such as a local area network or other communication protocol or over an available long-range wireless communication system such as a wide area network), Processor 502 may be configured to communicate with components within a vehicle through a short-range wireless communication system or wired system and with components outside of the vehicle through a long-range wireless communication system. In some embodiments, processor 508 may be configured to communicate through other wired or wireless vehicle communication systems.

User interface 506 may be any user interface disclosed herein. Processor 502 may be configured to receive commands from a user interface 506. In some embodiments, user interface 506 may be configured to receive input from a user or operator of the vehicle. A user or operator may turn the display on or off. A user or operator may determine to increase or decrease shading. A user or operator may provide inputs to indicate a command to display information associated with a feature of a landscape or seascape. The processor may receive any other input from a user or operator discussed herein. The processor may determine options for the user or operator based on other inputs or from a memory as discussed herein.

Display 508 may be any display disclosed herein. Processor 502 may be configured to receive information associated with a display 508 such as an on/off status, a shade level of the display, a light sensor associated with the display that detects a level of light on one or more of an exterior side and an interior side of the display, or any other information associated with the display consistent with disclosed embodiments. Processor 508 may provide one or more commands associated with the display 508 such as to turn on/off the display, to change a brightness of the display, to change the display, to update the display with information regarding a feature of a landscape or seascape, or any other commands consistent with disclosed embodiments.

Seat sensor 520 may be associated with sensing, recording, or storing information of a seat such as that used by an operator or user within a vehicle. Processor 502 may be configured to receive information associated with a seat sensor 520 such as an image, video, seat belt state, seat or backrest force sensor, or any other sensor consistent with disclosed embodiments. Processor 508 may provide one or more commands associated with the sensor 520 such as to turn on/off the sensor, to adjust the sensor such as a camera angle, a sensitivity of a sensor (e.g., lower/higher gain of a microphone, lower/higher force sensitivity of a force sensor, lower/higher aperture of a camera to allow/decrease allowed light) or any other sensor command consistent with disclosed embodiments.

Vehicle sensor 530 may be associated with sensing, recording, or storing information of a vehicle. Vehicle sensor 530 may be internal to the vehicle or external to the vehicle. Processor 502 may be configured to receive information associated with a vehicle sensor 530 such as a position of a vehicle (e.g., GPS position, position relative to destination, or any other position consistent with disclosed embodiments), a speed or velocity of the vehicle, a height of the vehicle, or any other position or vehicle information consistent with disclosed embodiments. Processor 508 may provide one or more commands associated with the vehicle sensor 520 such as to report current information, previous information, or predicted information regarding a vehicle (e.g., estimated time of arrival, velocity, speed) or any other command consistent with disclosed embodiments.

Database 540 may be any memory disclosed herein. Database 540 may be locally available on the vehicle or may be external to the vehicle. For example, database 540 may be one or more local memories or may be an external network such as a cloud database or internet-based database. Processor 502 may be configured to receive information associated with a database 540 such as a stored map, a current weather state or weather prediction, a location of an airport, information concerning a feature of a seascape or landscape, or any other information consistent with disclosed embodiments. Processor 508 may provide one or more commands associated with the database 540 such as to find or retrieve information or any other information consistent with disclosed embodiments.

It will be apparent to persons skilled in the art that various modifications and variations can be made to disclosed vehicle display systems. While illustrative embodiments have been described herein, the scope of the present disclosure includes any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application, which examples are to be construed as non-exclusive. Further, the steps of the disclosed methods may be modified in any manner, including by reordering steps and/or inserting or deleting steps, without departing from the principles of the present disclosure. It is intended, therefore, that the specification and examples be considered as exemplary only, with a true scope and spirit of the present disclosure being indicated by the following claims and their full scope of equivalents.

1. A display system comprising:
a processor,
one or more receivers configured to receive navigational information, wherein the processor is configured to determine a position of a vehicle based on the navigational information;
an optical sensor configured to capture an eye movement of a passenger of the vehicle; and
at least one screen that is configured to be translucent or transparent, wherein the at least one screen is configured to display data based on the navigational information and the eye movement.

2. The display system of claim 1, wherein the navigational information includes at least one of radionavigation information, satellite information, or area information.

3. The display system of claim 1, wherein the data comprises a visual graphic, text, or visual media.

4. The display system of claim 1, wherein at least part of the at least one screen is touchscreen.

5. The display system of claim 1, wherein the at least one screen is configured to display a shading.

6. The display system of claim 1, wherein the processor is configured to determine the position of the vehicle based on vehicle positional information from one or more vehicle sensors.

7. A non-transitory computer readable medium storing instructions that when executed by at least one processor, cause the at least one processor to perform functions comprising:
receiving navigational information,
determining a position of a vehicle based on the navigational information;
determining an environment of the vehicle; and
displaying the environment of the vehicle on at least one screen that is configured to be translucent or transparent, wherein the at least one screen is configured to display data based on the navigational information.

8. The non-transitory computer readable medium of claim 7, wherein the navigational information includes at least one of radionavigation information, satellite information, or area information.

9. The non-transitory computer readable medium of claim 7, wherein the data comprises a visual graphic, text, or visual media.

10. The non-transitory computer readable medium of claim 7, wherein the screen includes a touchscreen.

11. The non-transitory computer readable medium of claim 7, the functions further comprising projecting onto the data via a shading.

12. The non-transitory computer readable medium of claim 7, wherein wherein determining the position of the vehicle comprises determining the position of the vehicle based on vehicle positional information from one or more vehicle sensors.

13. The non-transitory computer readable medium of claim 12, wherein the vehicle positional information comprises an angle of attack, an airspeed, or a turn indicator.

14. A vehicle display comprising:
a processor;
one or more receivers configured to receive navigational information, wherein the processor is configured to determine a position of a vehicle based on the navigational information, wherein the processor is configured to determine a surrounding environment of the vehicle; and
at least one screen configured to be translucent or transparent, wherein the at least one screen is configured to display the surrounding environment of the vehicle with a data overlay.

15. The vehicle display of claim 14, wherein the navigational information includes at least one of radionavigation information, satellite information, or area information.

16. The vehicle display of claim 14, wherein the data comprises a visual graphic, text, or visual media.

17. The vehicle display of claim 14, wherein the at least one screen includes a touchscreen.

18. The vehicle display of claim 14, wherein the at least one screen is configured to project onto the data via a shading.

19. The vehicle display of claim 14, wherein the processor is configured to determine the position of the vehicle based on vehicle positional information from one or more vehicle sensors.

20. The vehicle display of claim 19, wherein the vehicle positional information comprises angle of attack, airspeed, or a turn indicator.
